(19) United States
(12) Patent Application Publication
(10) Pub. No.: US 2008/0282288 A1
(43) Pub. Date: Nov. 13, 2008

(54) REMOTE CONTROL UNIT AND REMOTELY OPERATING METHOD

(76) Inventor: Ji Min Heo, Gumi-city (KR)

Correspondence Address: KED & ASSOCIATES, LLP, P.O. Box 221200, Chantilly, VA, 20153-1200, US

(21) Appl. No.: 12/061,305

(22) Filed: Apr. 2, 2008

(30) Foreign Application Priority Data
May 10, 2007 (KR) 10-2007-0045335

(51) Int. Cl. G06F 13/10

(52) U.S. Cl. 725/39

(57) ABSTRACT

Provided is a remote control unit for remotely controlling an external device. The remote control unit includes a key input part having a plurality of keys, a wireless communication module, a memory device, a display part, and a controller. The wireless communication module transmits/receives data to/from the external device. The memory device stores key codes controlling operations of the external device, and electronic program guide information transmitted from the external device. The display part displays the electronic program guide information. The controller allows the electronic program guide information stored in the memory device to be output through the display part when a predetermined key of the key input part is input, and allows program information selected by manipulation of the key input part to be transmitted to the external device through the wireless communication module.

### CROSS-REFERENCE TO RELATED APPLICATIONS

The present application claims priority under 35 U.S.C. 119 and 35 U.S.C. 365 to Korean Patent Application No. 10-2007-0045335 (filed on May 10, 2007), which is hereby incorporated by reference in its entirety.

### BACKGROUND

Embodiments of the present disclosure relate to a remote control unit set to operate on a network, and a remotely operating method between the remote control unit and an image display device.

A wireless personal area network (WPAN) is technology that connects computers, peripheral devices, mobile communication terminals, home appliances, etc. located in a short distance of about 10 m through a wireless network to allow two way communication between devices, and supports various application fields.

The WPAN is discriminated from an existing local area network (LAN) or wide area network (WAN). The WPAN is one of small-scale wireless communication networks of a personal purpose.

Embodiment of the present disclosure provide a remote control unit and an image display device using the wireless communication network, and a method for controlling the image display device using the remote control unit.

### SUMMARY

Embodiments provide a remote control unit and a remotely operating method that allow a user to easily set wireless network settings, and more easily control an image display device using the set wireless network.

A proposed embodiment can be applied to a portable terminal that can receive broadcasting information. In this case, data reserved using the portable terminal can be delivered to a television (TV) through a server.

In one embodiment, a remote control unit for remotely controlling an external device, the remote control unit includes: a key input part having a plurality of keys; a wireless communication module transmitting/receiving data to/from the external device; a memory device storing key codes controlling operations of the external device, and electronic program guide information transmitted from the external device; a display part displaying the electronic program guide information; and a controller allowing the electronic program guide information stored in the memory device to be output through the display part when a predetermined key of the key input part is input, and allowing program information selected by manipulation of the key input part to be transmitted to the external device through the wireless communication module.

According to an embodiment, a user can electronic program guide information through the display part of the remote control unit, and furthermore, can use functions such as reservation of viewing or recording a specific program using the electronic program guide information even when the image display device is turned off.

Also, the remote control unit to which the spirit of the present disclosure is applied can be exemplified as a portable terminal that can perform wireless communication. In this case, a user can make a recording reservation of a broadcasting program using the portable terminal, and data of the set reservation recording can be delivered to a TV through a wirelessly connected server.

The details of one or more embodiments are set forth in the accompanying drawings and the description below. Other features will be apparent from the description and drawings, and from the claims.

### BRIEF DESCRIPTION OF THE DRAWINGS

FIG. 1 is a view illustrating the construction of a network system including a remote control unit according to an embodiment.

FIG. 2 is a block diagram explaining a remote control unit according to an embodiment.

FIG. 3 is a flowchart explaining in detail a method for setting a wireless network using a remote control unit according to an embodiment.

FIG. 4 is a schematic view illustrating the construction of an image display device according to an embodiment.

FIG. 5 is a flowchart explaining a remotely control method according to an embodiment.

FIGS. 6 and 7 are flowcharts explaining methods for updating electronic program guide (EPG) information stored in a remote control unit, respectively, according to an embodiment.

FIGS. 8 and 9 are a view and a flowchart of a system to which an embodiment of the present disclosure can be applied, respectively.

### DETAILED DESCRIPTION OF THE EMBODIMENTS

Reference will now be made in detail to the embodiments of the present disclosure, examples of which are illustrated in the accompanying drawings.

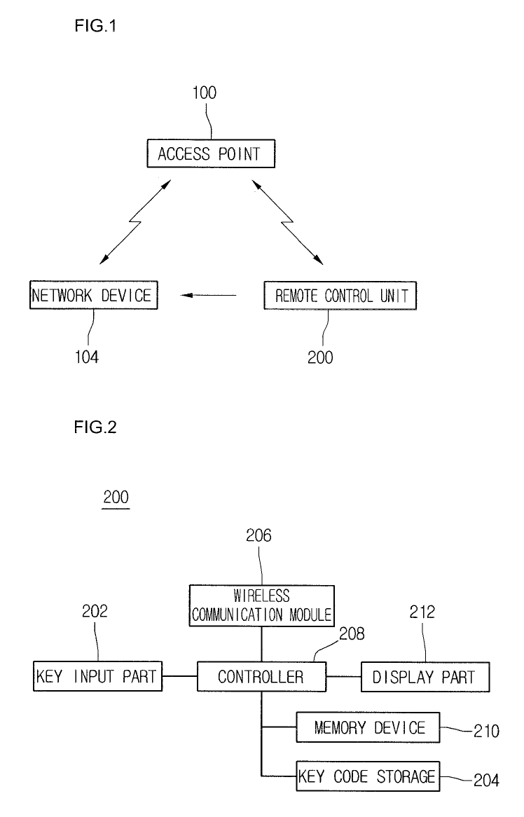

FIG. 1 is a view illustrating the construction of a network system including a remote control unit according to an embodiment.

The network system includes an access point 100 forming a wireless network, a network device 104 such as a network TV receiver and a network DVD player, and a remote control unit 200 allowing the network device 104 to access the network formed by the access point 100.

The remote control unit 200 may be a unit for remotely controlling the operation of the network device 104. Also, in the case where the access point 100 has a user interface, it can be used as a unit controlling the operation of the access point 100.

Network settings of network devices 104 are performed using the remote control unit 200.

In detail, the remote control unit 200 for controlling each network device 104 has an internal memory device, and is configured to perform data communication with the access point 100. Also, the remote control unit 200 obtains network setting information from the access point 100. The network setting information is necessary for allowing the network device 104 to access the network formed by the access point 100.

Therefore, a universal serial bus (USB) type wireless communication module is provided to the access point 100 to allow the remote control unit 200 that performs data communication with the network device 104 through an ultraviolet ray or a radio frequency (RF) communication module to also perform data communication with the access point 100.

The remote control unit 200 for the network devices 104 stores network setting information obtained from the access point 100 in the internal memory device. Also, when a user's network setting request is input, the network setting information stored in the internal memory device is transmitted together with a setting command requesting network setting from the remote control unit 200 to the network device 104.

As described below, the remote control unit 200 should have a memory device for storing EPG information transmitted from an external device. The memory device for storing the EPG information, and the memory device for storing the network setting information may be separately provided, or the EPG information and the network setting information may be stored in the same memory device depending on embodiments.

The network device 104 receives the network setting command and the setting information of the network formed by the access point 100 transmitted by the remote control unit 200, and tries an access to the access point 100 using the received network setting information to access the network formed by the access point 100.

Through the above process, the user can use various functions provided by the network device 104 on the network formed by the access point 100.

Network setting by the network device through the remote control unit is described in more detail according to a proposed embodiment.

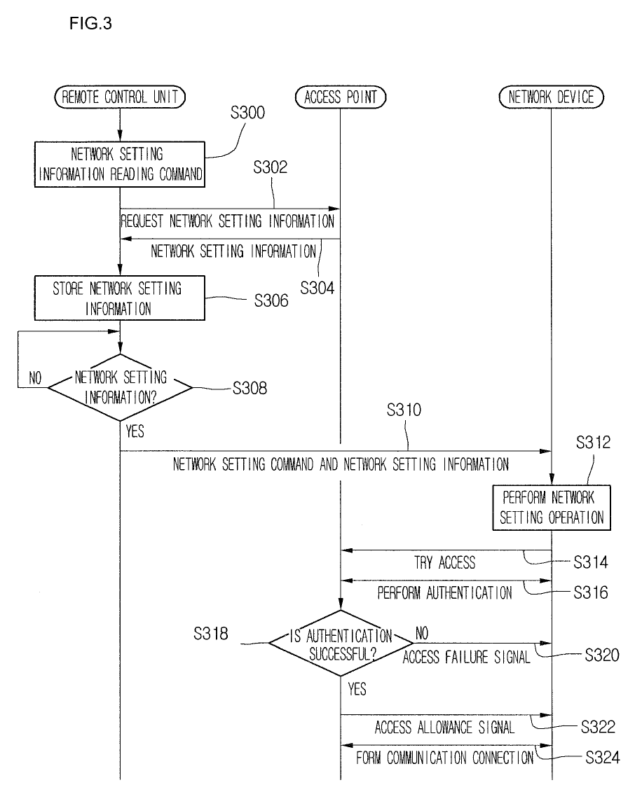

FIG. 2 is a block diagram explaining a remote control unit according to an embodiment.

When a user manipulates the remote control unit 200 according to the embodiment to input a network setting command, the remote control unit 200 receives network setting information from the access point 100 and stores the same, and transmits the stored network setting information to the network device 104, so that the network device 104 can access the network formed by the access point 100 using the received network setting information.

In detail, referring to FIG. 2, the remote control unit 200 according to the proposed embodiment includes a wireless communication module 206 performing data communication with the access point 100 or the network device 104, a key input part 202 having a plurality of input keys, a memory device 210 storing network setting information, and EPG information received from the network device, a key code storage 204 storing key code values to be transmitted through the wireless communication module 206, a display part 212 displaying the EPG information, and a controller 208 controlling the operation of the remote control unit 200.

The key input part 202 have a plurality of input keys, and includes a first input key receiving a user's command to perform an operation for reading network setting information from the access point 100, a second input key receiving the user's command to perform an operation for transmitting a network setting command and network setting information to the network device, and a third input key receiving the user's command to allow EPG information to be displayed on the display part 212 of the remote control unit 200.

That is, when the first input key is input, a signal requesting network setting information is transmitted from the remote control unit 200 to the access point 100. The access point 100 that has received the signal requesting network setting information transmits setting information regarding a formed network to the remote control unit 200.

Also, when the second input key is input, the remote control unit 200 transmits the network setting information stored already to the network device together with a signal requesting network setting (network setting command).

The network device that has received the network setting command and the network setting information transmitted from the remote control unit 200 tries an access to the network formed by the access point 100 using the network setting information.

Meanwhile, the third input key is designed for allowing the user to use EPG information through the display part 212 of the remote control unit 200. In this case, the network device can be an image display device such as a digital TV. In the case where the network device is an image display device according to an embodiment of the present disclosure, utilization of the EPG information using the remote control unit 200 is described below with reference to the accompanying drawings.

The key code storage 204 stores key codes for controlling the operations of the network device in response to key selection of the plurality of input keys provided to the key input part 202. When each key provided to the key input part 202 is input, the controller 208 reads a corresponding key code from the key code storage 204 and allows the read key code to be transmitted through the wireless communication module 206.

For example, when the first input key is input, the controller 208 reads data requesting the access point 100 to transmit network setting information from the key code storage 204, and allows the read data to be transmitted through the wireless communication module 206.

Also, a key code of the second input key can be data of a command requesting the network device to perform an operation for network setting. At this point, the controller 208 allows network setting information stored already to be transmitted together with the key code of the second input key when the second input key is input.

In the remote control unit 200 according to the embodiment, though the memory device 210 and the key code storage 204 are discriminated as data storing means, a single memory device can be used in realizing the embodiment.

The wireless communication module 206 can perform wireless communication with the network device and the access point, and can be formed using an infrared (IR) communication module.

The controller 208 controls the remote control unit to operate according to the user's operating command input through the key input part 202. The operation of the remote control unit 200 in the case where the first input key and the second input key are input is described first, and an EPG information using method associated with the third input key will be described later.

When the first input key provided to the key input part 202 is input, the controller 208 reads a command (key code) corresponding to input of the first input key, that is, a network setting information request command for reading network setting information from the access point forming the network from the key code storage 204.

Also, the controller 208 controls the read command to the transmitted through the wireless communication module 206. The access point that has received the transmitted command transmits network setting information set as a response to the received command to the remote control unit 200.

In this case, the controller 208 stores the network setting information received through the wireless communication module 206 in the memory device 210.

When the second input key is input, the controller 208 reads a command corresponding to input of the second input key, that is, a network setting command requesting the network device to perform a network setting operation from the key code storage 204, and reads the network setting information received from the access point from the memory device 210.

Next, the controller 208 allows the network setting command and the network setting information to be transmitted to the network device through the wireless communication module 206.

That is, to allow the network device to access the wireless network, the remote control unit 200 according to the proposed embodiment reads the network setting information from the access point forming the wireless network, and transmits the read information to the network device, thereby performing a network setting operation.

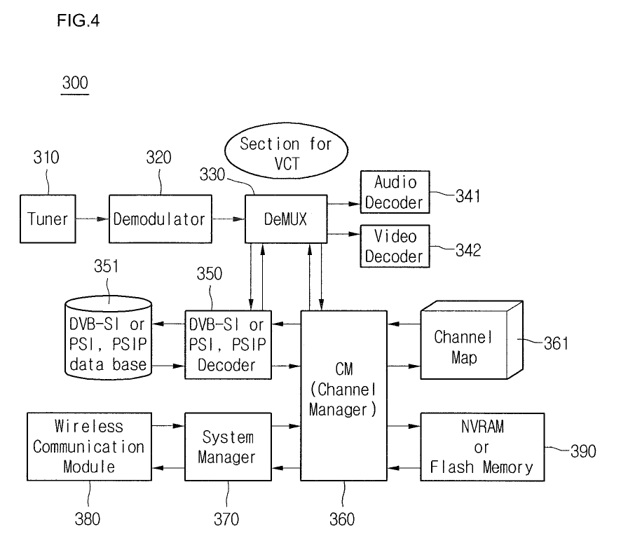

FIG. 3 is a flowchart explaining in detail a method for setting a wireless network using a remote control unit according to an embodiment.

When the remote control unit for the network device on which a network setting operation is to be performed receives a network setting information read command from a user (S300), the remote control unit transmits a command requesting network setting information including identifier information of the access point to the access point forming the wireless network (S302).

Also, the access point transmits the network setting information regarding the network formed by the access point to the remote control unit in response to the network setting information requesting command transmitted from the remote control unit (S304) At this point, the remote control unit stores the network setting information transmitted from the access point (S306).

Also, when the user's network setting command is input (S308), the remote control unit reads a network setting command requesting the network device to perform a network setting operation from the key code storage, and transmits the read command together with the already stored network setting information (S310).

Here, the network setting information transmitted by the access point can include identifier information of the access point and wireless network authentication information.

Therefore, in case of the access point forming a wireless LAN network for example, the access point transmits network setting information including service set identifier (SSID), which is information necessary for accessing the access point itself, according to a wireless LAN communication method.

Also, in the case where the access point forming the wireless LAN network allows an access through a network authentication process, the access point can transmit the network setting information including wired equivalent privacy (WEP) key information, which is network authentication key information.

Therefore, a network setting operation is performed using a network setting command and network setting information from the remote control unit (S312). When the operation using the network setting information is completed, an access to the access point that has provided the network setting information is tried (S314), and a network allowing data communication is formed.

As described above, in the case where the network device accesses the wireless network through an access to the access point forming the wireless LAN network, the network device receives network setting information including SSID of the access point through the remote control unit.

Also, the network device performs a network setting operation using the received network setting information, tries an access to a corresponding access point using the SSID within the network setting information, and forms communication connection with the access point.

A method allowing an access of a network device through only the SSID of the access point in a wireless LAN is called an open system method.

Also, in case of an access point that uses a shared key authentication method, which is another authentication method, in a wireless LAN, the access point provides network setting information further including WEP key information as network authentication key information in response to a network setting information transmission request of the remote control unit.

By doing so, the network device performs a network setting operation using the network setting information including the SSID of the access point and the WEP key information provided from the remote control unit, and tries an access to the access point to check whether the same WEP key has been set through a shared key authentication process when the operation is completed (S316).

When it is checked that the same WEP key as that of the access point has been set to the network device as a result of the checking, that is, when the authentication process is successful, an access allowing signal to an access try of the network device is transmitted to the network device from the access point (S318 and S322).

The network device that has received the access allowing signal from the access point receives an Internet protocol (IP) address, and a gateway address for communication from the access point to form communication connection with the access point (S324), and participates in the wireless network formed by the access point.

A data communication method between the remote control unit and the image display device is described below using the image display device as the network device for an example.

That is, in an embodiment described below, the image display device is exemplarily used as the network device, and data communication between the image display device and the remote control unit is described. Though the access point and the network device are discriminated in association with network setting according to the foregoing, a separate access point besides the image display device may not be necessarily formed because the embodiment described below can be realized by data communication between the image display device and the remote control unit.

Therefore, in understanding the embodiment described below, the above-described case where the image display device accesses the network formed by the access point, and the case where data communication is performed between the image display device and the remote control unit without a separate access point need to be considered. That is, the image display device can be configured to serve as both a network device and an access point simultaneously.

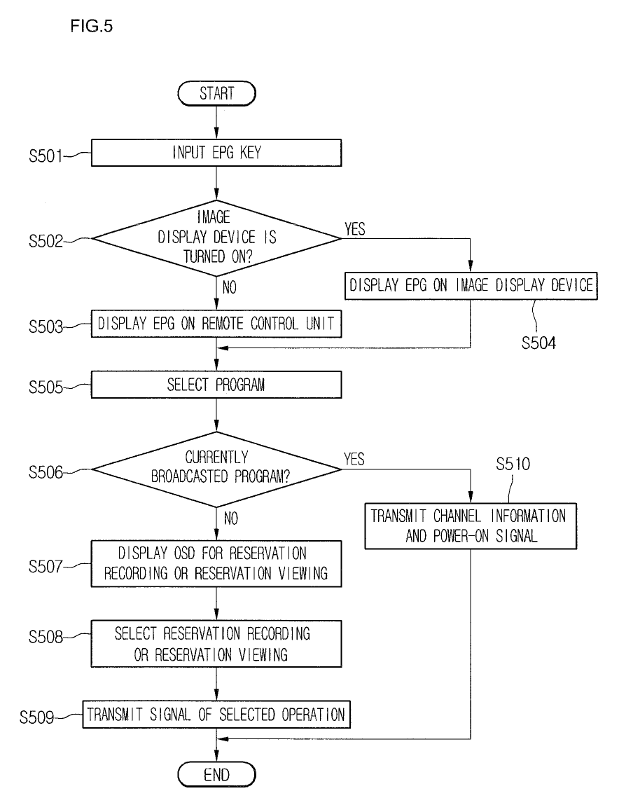

The construction of the image display device according to an embodiment is described with reference to FIG. 4, and data communication between the image display device and the remote control unit is described with reference to FIGS. 2, 4, 5, and 7.

FIG. 4 is a schematic view illustrating the construction of an image display device according to an embodiment.

Referring to FIG. 4, the image display device 300 includes a tuner 310 receiving transmitted broadcasting signals and tuning and outputting signals of a specific channel selected by a user, a demodulator 320 demodulating the channel selected through the tuner 310 by the user, a demultiplexer (DeMUX) 330 demultiplexing the demodulated signals into audio, video, digital video broadcast service information (DVB-SI) table, and program and system information protocol (PSIP) table, an audio decoder 341 decoding and outputting audio signals of the demultiplexed signals, and a video decoder 342 decoding and outputting video signals of the demultiplexed signals.

Also, the image display device 300 includes a DVB-SI or PSIP decoder 350 decoding the DVB-SI table or PSIP table, a DVB-SI or PSIP database (DB) 351 storing decoded results, a channel manager (CM) 360 for channel management, a channel map 361 on which channel information has been recorded, a wireless communication module 380 for data communication with the external remote control unit, a system manager 370 (which can be expressed as a “controller” of the image display device in the described below) allowing data communication with an external device through the wireless communication module 380, and providing a user interface, and a memory device (non-volatile (NV) RAM) or flash memory) 390 storing the channel map information.

The operation of the image display device 300 having the above-described construction is described below.

When a user manipulates a channel key of the key input part of the remote control unit, the image display device 300 receives input of the channel key through the system manager 370. When the channel key is input, the channel manager 360 reads the frequency of a channel of channel information stored in the channel map 361 and corresponding to the input channel key.

The channel manager 360 sets the tuner 310 according to the read channel frequency to allow the channel selected by the user to be tuned. Signals tuned by the tuner 310 are demodulated by the demodulator 320 and then output to the demultiplexer 330.

Meanwhile, when tuning is performed on the channel selected by the tuner 310, a signal informing that tuning has been performed is transmitted to the channel manager 360. The channel manager 360 transmits information of the tuned channel to the DVB-SI or PSIP decoder 350 to set a base packet identification (PID) for finding out a master guide table (MGT) and a virtual channel table (VCT), or a PID for finding out an application information table (AIT) to the demultiplexer 330.

The demultiplexer 330 finds out the MGT, the VCT, or the AIT from signals demodulated by the demodulator 320 using the PID, and demultiplexes the same. A relevant event information table is found through a PID of an event information table included in the above demultiplexed MGT, and information obtained by parsing the event information table is stored in the DVB-SI or PSIP DB 351.

Also, information obtained by parsing the AIT is stored in the DVB-SI or PSIP DB 351, and the information stored in the DVB-SI or PSIP DB 351 is transmitted to the channel manager 360.

Meanwhile, the image display device 300 includes the wireless communication module 380 allowing data communication with the remote control unit illustrated in FIG. 2. The system manager 370 allows EPG information received in an out-of-band (OOB) to be transmitted to the remote control unit through the wireless communication module 380.

For reference, though a process of processing data broadcasting is omitted in the image display device illustrated in FIG. 4, the process of receiving and processing the data broadcasting is known in the art. Therefore, the image display device 300 stores EPG information received through the tuner 310, and the stored EPG information is transmitted to the external remote control unit through the wireless communication module 380 of the image display device under control of the system manager 370.

Here, the image display device 300 and the remote control unit 200 maintain connection to the wireless network. In this case, the system manager 370 of the image display device 300 controls the EPG information received through the tuner 310 to be transmitted to the remote control unit 200 through the wireless communication module 380.

In relation to the above-described setting of the wireless network, network setting between the image display device 300 and the remote control unit 200 is completed, the system manager 370 transmits the already stored EPG information to the remote control unit 200. The remote control unit 200 that has received the EPG information stores the received EPG information in its memory.

Therefore, the user can check the EPG information through the remote control unit 200 without turning on the power of the image display device.

Here, for the EPG information displayed through the remote control unit 200, still images or moving images for allowing the user to easily check the contents of a broadcasting program can be displayed together in the form of thumbnails.

That is, the received EPG information may include thumbnail information so that the user can easily understand the contents of a broadcasting program through the display part of the remote control unit.

For reference, since both the remote control unit and the image display device have a wireless communication module for data communication, each wireless communication module can be discriminated by a corresponding reference numeral.

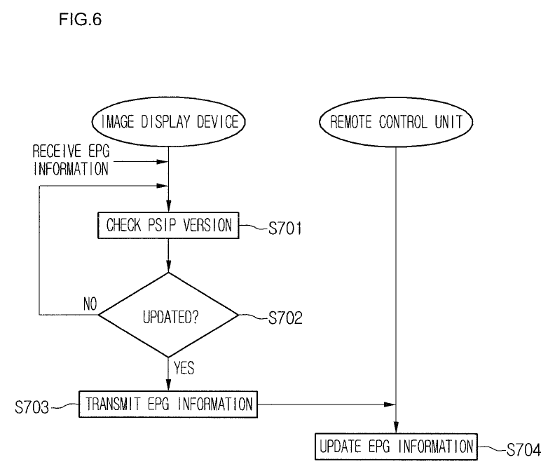

Data communication between the image display device 300 and the remote control unit 200 is described below with reference to FIG. 5. The third input key mentioned in the description of FIG. 2 is described together.

FIG. 5 is a flowchart explaining a remotely control method according to an embodiment. EPG information transmitted from the image display device 300 is already stored in the remote control unit 200 according to the embodiment.

For reference, a case where power of the image display device is turned off is described in the detailed description of an embodiment of the present disclosure. The following is noted in relation to the power-off state of the image display device.

That is, a related art image display device can receive only a power-on command from the remote control unit during a power-off state, but the image display device according to an embodiment is configured such that the communication module receiving wireless signals transmitted from the remote control unit, and elements processing received signals may operate. In this case, vide/audio decoders do not operate as that of the related art image display device.

The user inputs the third input key (e.g., EPG key) provided to the remote control unit 200, thereby requesting the EPG information to be output through the display part 212 of the remote control unit 200 (S501).

Also, when the third input key is input, the controller 208 of the remote control unit 200 judges whether power of the image display device 300 connected to the wireless network is turned on (S502).

When the power of the image display device 300 is turned on, the image display device 300 receives a key code (command) regarding the third input key transmitted from the remote control unit 200, so that EPG information is displayed on a screen of the image display device through an EPG generator (not shown in FIG. 4) of the image display device.

On the other hand, when the power of the image display device 300 is turned off, the EPG information stored in the memory device 210 is displayed through the display part 212 of the remote control unit 200.

Here, the remote control unit 200 should be able to judge whether the power of the image display device 300 connected to the wireless network is turned on. Since information channel being viewed by the user right before the power-off of the image display device 300 is stored in the memory device 390 (e.g., NVRAM or flash memory) of the image display device 300 when the power of the image display device 300 is turned off, information of the stored channel is transmitted to the remote control unit 200 through the wireless communication module 380 of the image display device 300. The remote control unit 200 that has received the channel information confirms the power of the image display device 300 is turned off.

Meanwhile, besides the above-described method, the remote control unit 200 can detect the power-on/off of the image display device 300 by allowing a signal informing that the power of the image display device 300 has been turned off to be transmitted from the image display device 300 to the remote control unit 200.

Also, in the case where a key code allowing the power of the image display device to be turned on, and a key code allowing the power of the image display device to be turned off are separately provided in relation to the power-on/off of the image display device 300, the remote control unit does not need to receive data including the power-on/off from the image display device.

In the case where the power of the image display device is turned off, EPG information stored in the memory device 210 is displayed through the display part 212 of the remote control unit 200 as described above, and the user can manipulate the keys of the remote control unit to select one channel or program on the displayed EPG information.

In this case, the controller 208 judges whether the program selected by the user is a program being currently broadcasted (S506). When the program selected by the user is the program being currently broadcasted as a result of the judgment, information of the channel selected by the user is transmitted together with a key code commanding the power-on of the image display device through the wireless communication module 206 of the remote control unit (S510).

That is, in the case where the power of the image display device is turned off and the program selected by the user on the EPG information output through the remote control unit is the program being currently broadcasted, a key code corresponding to a channel through which the selected program is broadcasted is transmitted from the remote control unit 200 to the image display device 300 together with a key code turning on the power of the image display device 300. Accordingly, the image display device 300 is turned on and allows the channel through which the program selected by the user is broadcasted to be displayed.

Also, when wireless signals transmitted from the remote control unit 200 contain information regarding the channel on an initial screen as described above, the image display device 300 deletes the information of the channel already stored in the memory device (NVRAM or flash memory) 390 and then stores the received initial channel.

Meanwhile, when the channel or program selected by the user on the EPG information output through the display part 212 of the remote control unit 200 is not the program being currently broadcasted, the image display device 300 and the remote control unit 200 perform a process for reservation viewing or reservation recording (here, recording of a broadcast program includes both recording a program being currently broadcasted and reservation recording) (S507).

That is, when the channel or program selected by the user on the EPG information output through the remote control unit 200 is not the program being currently broadcasted, the controller 208 of the remote control unit allows a user interface for reservation viewing or reservation recording of the selected program to be output through the display part 212.

Also, the user views an on-screen-display (OSD) for reservation viewing or reservation recording output through the display part 212 of the remote control unit 200 to select a reservation method of the selected program (S508).

Next, the controller 208 of the remote control unit modulates information of reservation viewing or reservation recording selected by the user into a wireless signal, and allows the signal to be transmitted through the wireless communication module 206 (S509).

In this case, the wireless signal transmitted from the remote control unit 200 contains information requesting viewing or recording together with information of the program selected by the user. The image display device 300 that has received the signal stores the received information of the program and prepares an operation for viewing or recording the corresponding program.

That is, the image display device 300 turns on the power of the image display device 300 on a time at which the program whose information has been received is broadcasted to allows a channel through which the program is broadcasted to be displayed, or records demodulated signals obtained by tuning the channel and output through the video and audio decoder on a time at which the program whose information has been received is broadcasted.

The reservation recording by the image display device can be performed by turning on a screen panel of the image display device and then performing a recording operation, or by storing signals output from the audio decoder 341 and the video decoder 342 in a recording medium (e.g., hard disc drive (HDD)) without displaying the signals on the screen panel (or without operating a scaler) depending on the user's selection.

Through the above-described methods, the user can view the EPG information output through the display part 212 of the remote control unit to turn on the image display device for a specific channel, or make reservation viewing or reservation recording of a specific program. In this case, since the image display device 300 should be able to receive signals transmitted from the remote control unit and perform predetermined operations even when the power of the image display device 300 is turned off, the tuner 310, the demodulator 320, the demultiplexer 330, the CM 360, and the system manager 370 should remain activated as described above.

The EPG information transmitted from the image display device to the remote control unit and stored in the memory device of the remote control unit is described below, and particularly, a method of updating the EPG information stored in the memory device of the remote control unit is described.

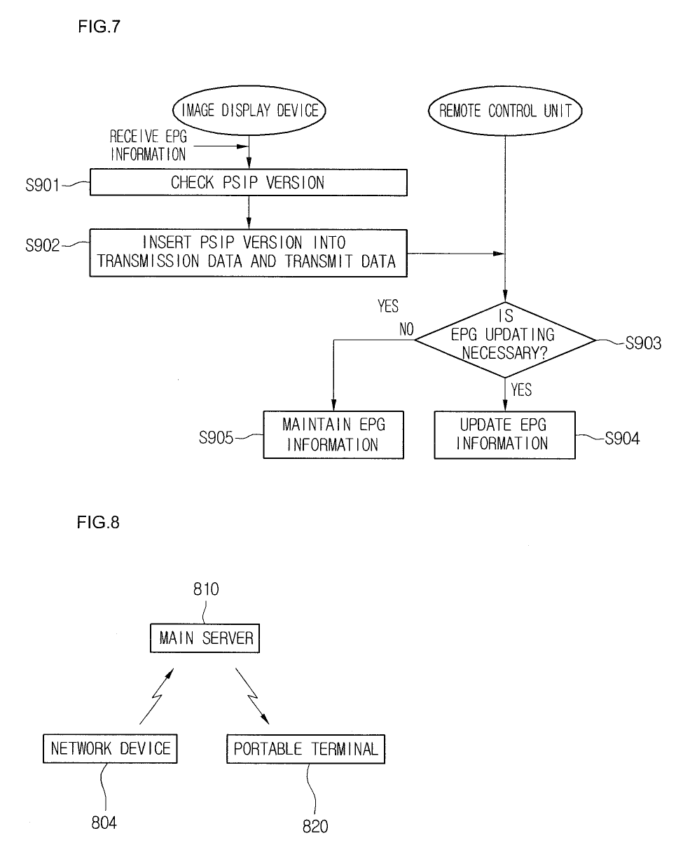

FIGS. 6 and 7 are flowcharts explaining methods for updating EPG information stored in the remote control unit, respectively, according to an embodiment.

FIG. 6 illustrates a method of judging, at the image display device, whether EPG information has been updated, and transmitting updated EPG information to the remote control unit when the EPG information has been updated as a result of the judgment.

FIG. 7 illustrating a process of judging, at the remote control unit that has received the EPG information transmitted from the image display device, whether the EPG information has been updated, and performing updating of the already stored EPG information as a result of the judgment.

Referring to FIG. 6, the image display device receives data broadcasting through the OOB besides receiving image signals through an in-band. The data broadcasting contains EPG information.

The image display device checks PSIP information from the received EPG information (S701), and judges whether the EPG information already stored in the image display device has been updated (S702).

When the EPG information has been updated as a result of the judgment on the basis of the received PSIP information, the updated EPG information is transmitted to the remote control unit through the wireless communication module (S703).

In this case, the remote control unit that has received the EPG information transmitted from the image display device replaces the EPG information stored in the memory device with the newly received EPG information and stores the same (S704). In this case, the construction of a circuit part of the controller of the remote control unit can be more simplified. The remote control unit updates EPG information stored in the internal memory whenever EPG information is received from the image display device to allow the user to use the latest EPG information.

Also, referring to FIG. 7, the image display device checks a PSIP version from received EPG information (S901), and inserts the PSIP version into wireless data to be transmitted to the remote control unit and transmits the same (S902).

In this case, the remote control unit extracts PSIP information from received wireless data, and then compares the extracted PSIP information with PSIP information of the EPG information stored in the internal memory device to judge whether to update the EPG information (S903).

When the EPG information has been updated as a result of the judgment, the EPG information stored in the internal memory device is updated. The updating of the EPG information at the remote control unit is performed by transmitting, at the remote control unit, a signal requesting transmission of the EPG information to the image display device, and transmitting, at the image display device that has received the signal, EPG information corresponding to a PSIP version of the requested EPG information to the remote control unit (S904).

Meanwhile, when the remote control unit that has checked the PSIP version judges the updating of the EPG information is not necessary, the EPG information already stored in the internal memory device is maintained (S905).

Though not shown in the drawings, the image display device can be configured to periodically transmit received PSIP version to the remote control unit. In this case, the EPG information stored in the remote control unit is periodically updated.

In the above description, though the remote control unit having the construction illustrated in FIG. 2 has been described, the remote control unit can be applied to a portable terminal that allows digital multimedia broadcasting (DMB) viewing.

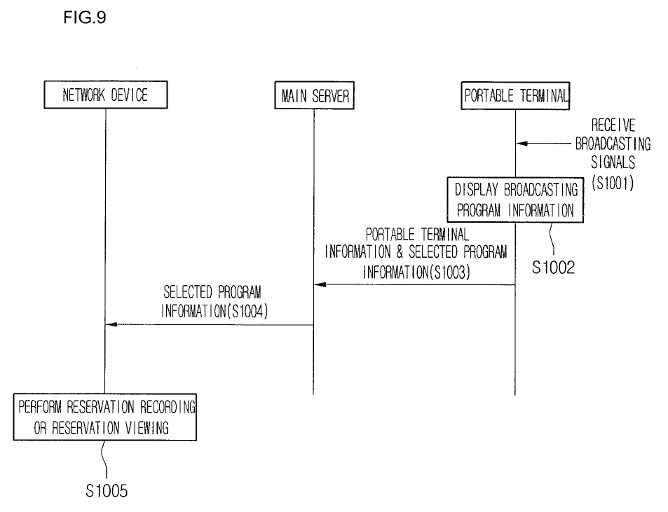

That is, the spirit of the present disclosure can be applied to the portable terminal that can receive information of a broadcasting program. The construction of the portable terminal is illustrated in FIGS. 8 and 9.

FIGS. 8 and 9 are a view and a flowchart of a system to which an embodiment of the present disclosure can be applied, respectively.

A portable terminal 820 includes a memory device storing information of a received broadcasting program, a display part displaying the received broadcasting program to a user, and a wireless communication module allowing contents set by the user to be transmitted wirelessly as illustrated in FIG. 2.

The portable terminal 820 has the wireless communication module to allow voice communication wirelessly, and can perform data transmission to a main server 810 using the wireless communication module.

Here, in the case where the portable terminal 820 is a terminal allowing DMB viewing, EPG information may be transmitted together with wirelessly received broadcasting signals. The portable terminal 820 can be configured to download information of a broadcasting program through a wired line or wirelessly. That is, the portable terminal 804 stores information of a received or downloaded broadcasting program (S1001).

Since the method for storing the information of a broadcasting program in the portable terminal 820, and the construction thereof may be sufficiently realized by a related art and may be achieved by the construction illustrated in FIG. 1, detailed description thereof is omitted.

A user can check the information of a broadcasting program by manipulating the portable terminal 820 (S1002), and can input contents regarding reservation recording or reservation viewing of the broadcasting program by manipulating input keys of the portable terminal.

The contents input or set by the user through the portable terminal 820 is delivered to the main sever 810 wirelessly. The main server 810 reads the information of the portable terminal and the broadcasting reservation set by the user from signals transmitted from the portable terminal 820 (S1003).

Also, the main server 810 explores a network device set to operate on a network using the information of the portable terminal 820, and connects to a network device 804 on which transmission is to be performed.

The main server 810 transmits contents related to the reservation recording or reservation viewing of the broadcasting program set by the user to the network device 804 (S1004).

Next, the network device 804 that has received signals delivered from the main server 810, that is, a digital TV set to operate on a home network operates to perform the reservation recording or reservation viewing of the broadcasting program according to the contents set by the user of the portable terminal (S1005).

According to the above-described various embodiments, a wireless network is formed between the image display device and the remote control unit controlling the operation of the image display device, so that remote controlling of the image display device can be more easily performed.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A remote control unit for remotely controlling an external device, the remote control unit comprising:
a key input part having a plurality of keys;
a wireless communication module transmitting/receiving data to/from the external device;
a memory device storing key codes controlling operations of the external device, and electronic program guide information transmitted from the external device;
a display part displaying the electronic program guide information; and
a controller allowing the electronic program guide information stored in the memory device to be output through the display part when a predetermined key of the key input part is input, and allowing program information selected by manipulation of the key input part to be transmitted to the external device through the wireless communication module.

2. The remote control unit according to claim 1, wherein the controller judges whether the selected program information is information of a program being currently broadcasted, and transmits a key code corresponding to one of viewing, general recording, and reservation recording of a program whose information has been selected depending on a result of the judgment.

3. The remote control unit according to claim 1, wherein the controller transmits a key code for turning on power of the external device together with the selected program information when the selected program information is information of a program being currently broadcasted.

4. The remote control unit according to claim 1, wherein the controller reads whether power of the device is turned on or off from data received through the wireless communication module, and transmits a key code for turning on the power of the external device together with the selected program information when the selected program information is information of a program being currently broadcasted and the power of the device is judged to be turned off.

5. The remote control unit according to claim 1, wherein the controller transmits a key code requesting reservation recording together with the selected program information when the selected program information is not information of a program being currently broadcasted.

6. The remote control unit according to claim 1, wherein the controller reads program and system information protocol version information from data received through the wireless communication module, and judges whether to update the electronic program guide information stored in the memory device using the read program and system information protocol version information.

7. The remote control unit according to claim 1, wherein the controller updates the electronic program guide information stored in the memory device whenever electronic program guide information is received through the wireless communication module.

8. The remote control unit according to claim 1, wherein the electronic program guide information displayed through the display part comprises thumbnails including one of still images and videos.

9. A remote control unit comprising:
a wireless communication module performing wireless communication with a network device set to operate on a network;
a key input part comprising a first input key, a second input key, and a third input key, the first input key requesting a reading operation of network setting information, the second input key requesting network setting according to the read network setting information, and the third input key requesting checking of stored electronic program guide;
a display part displaying the electronic program guide;
a key code storage storing key codes of data to be transmitted when the first to third input keys are input, and a memory device storing the electronic program guide information; and
a controller reading the key code stored in the key code storage and controlling the read key code to be transmitted through the wireless communication module according to an input key input through the key input part, the controller transmitting a command requesting the network setting information through the wireless communication module when the first input key is input, storing received network setting information in the memory device, and transmitting a command requesting network setting together with the stored network setting information when the second input key is input.

10. The remote control unit according to claim 9, wherein the electronic program guide information is transmitted together with the network setting information from the network device that has received the command requesting the networking setting.

11. The remote control unit according to claim 9, wherein the controller judges whether to update the electronic program guide depending on whether program and system information protocol version transmitted from the network device changes.

12. The remote control unit according to claim 9, wherein the controller judges whether power of the network device is turned off using data received through the wireless communication module, and transmits a key code for turning on the power of the network device together with information of a selected program when the power of the network device is turned off and the program selected by a user on the electronic program guide information displayed through the display part is a program being currently broadcasted as a result of the judgment.

13. The remote control unit according to claim 9, wherein the controller judges whether power of the network device is turned off using data received through the wireless communication module, and transmits a signal requesting reservation recording of a selected program together with information of the selected program when the power of the network device is turned off and the program selected by a user on the electronic program guide information displayed through the display part is not a program being currently broadcasted as a result of the judgment.

14. The remote control unit according to claim 9, wherein the remote control unit comprises a portable terminal allowing voice communication wirelessly.

15. A remotely operating method comprising:
transmitting data requesting network setting information from a remote control unit controlling an operation of a network device to an access point forming a wireless network;
transmitting the network setting information from the access point that has received the data requesting the network setting information, and storing, at the remote control unit, the transmitted network setting information;
transmitting, at the remote control unit, the network setting information together with a command requesting network setting;
performing, at the network device that has received the command requesting the network setting, a network setting operation using the network setting information;
trying, at the network device, an access to the access point to form communication connection; and
after the communication connection, transmitting electronic program guide information from the network device, and storing, at the remote control unit, the transmitted electronic program guide information.

16. The method according to claim 15, further comprising transmitting, at the remote control unit, information of a program selected by a user to the network device, the data transmitted from the remote control unit comprising data for turning on power of the network device when the selected program is a program being currently broadcasted.

17. The method according to claim 15, wherein the network device comprises an image display device receiving a broadcasting channel and a data channel, the network device accessing the access point to form communication connection, then reading electronic program guide information and program and system information protocol version information of the electronic program guide information from the received data channel, and transmitting the read information to the remote control unit.

18. The method according to claim 15, wherein the transmitting, at the network device, of the electronic program guide information is performed by a period set by the user.
